(19) United States
(12) Patent Application Publication
(10) Pub. No.: US 2007/0227031 A1
(43) Pub. Date: Oct. 4, 2007

(54) Insertion coupling type fan housing and dryer having the same

(75) Inventor: Hyoung Tae Yoon, Gyeyang-gu (KR)

Correspondence Address: THE NATH LAW GROUP PLLC, 112 South West Street, Alexandria, VA, 22314, US

(73) Assignee: DAEWOO ELECTRONICS CORPORATION, Seoul (KR)

(21) Appl. No.: 11/727,704

(22) Filed: Mar. 28, 2007

(30) Foreign Application Priority Data
Mar. 29, 2006 (KR) 10-2006-28637

(51) Int. Cl. F26B 25/00; F26B 11/02

(52) U.S. Cl. 34/242; 34/604; 34/607

(57) ABSTRACT

An insertion coupling type fan housing and a dryer having the same are disclosed. The fan housing includes a main body which houses an exhaust fan and is formed with an inflow hole, a cover which is coupled to the main body to form an airtight space and is formed with an out flow hole, a coupling member which are formed at a circumference of the cover, a coupling hole which is formed at a circumference of the main body correspondingly to the coupling member so that the coupling member is inserted into the coupling hole, and a sealing part which is mounted between the main body and the cover to prevent air from leaking through a gap between the main body and the cover. Accordingly, since the fan housing is constituted by coupling the main body and the cover by inserting the coupling member of the cover into the coupling hole of the main body, assembly efficiency can be increased.

### CROSS-REFERENCES TO RELATED APPLICATIONS

The present application claims priority to Korean patent application number 10-2006-0028637, filed on Mar. 29, 2006, which is incorporated by reference in its entirety.

### BACKGROUND OF THE INVENTION

The present invention relates to an insertion coupling type fan housing and a dryer having the same, and more particularly to an insertion coupling type fan housing which is constituted by coupling a main body and a cover by an insertion method, thereby increasing assembly efficiency, and a dryer having the above fan housing.

In general, a clothes dryer is a device for drying clothes by blowing dry hot air heated by a heater into an accommodating space in which clothes to be dried are accommodated. A conventional dryer is disclosed in Korean Patent Laid-open Publication No. 10-2005-0061878.

FIG. 1 is a schematic view illustrating a constitution of a conventional dryer, and FIG. 2 is a perspective view illustrating a constitution of a conventional dryer.

As shown in the drawings, a conventional dryer comprises a case 2 which forms an external appearance of the dryer and has an opening through which objects to be dried are thrown thereinto, a drum 12 which is rotatably mounted inside the case 2 to accommodate the objects to be dried and has opened front and rear portions for passing air therethrough, a heater 18 which is disposed inside the case 2 to heat air sucked into the case 2, an inflow duct 20 which guides the heated air passing through the heater 18 to the rear of the drum 12, an exhaust unit 22 which exhausts foul air used for drying the objects to be dried out of the case 2, a blower fan (not shown) which is mounted to the exhaust unit 22, and a motor (not shown) and a belt 40 which drive the drum 12 and the blower fan.

A lifter 11 for lifting up and subsequently dropping the objects to be dried is mounted in the drum 12.

The exhaust unit 22 includes a lint duct 25 which receives the air from the drum 12 and is provided with a filter 24 for filtering foreign substances, a fan housing 26 which communicates with the lint duct 25 and houses the blower fan (not shown), and an exhaust duct 27 which communicates with the fan housing 26 at one end and extends outside the case 2.

The fan housing 26 is constituted by a main body and a cover to provide a space for mounting the blower fan, and has a suction hole and an exhaust hole through which air passes by the operation of the blower fan.

The blower fan is installed inside the main body, and then a cover is coupled to the main body. The cover is fixed to the main body by performing a welding process such as heat welding or ultrasonic welding to contact surfaces between the cover and the main body.

An operation of the conventional dryer structured as above will now be described.

Firstly, the objects to be dried are thrown into the drum 12, and the door is closed. Then, if operating the dryer, the drum 12 and the blower fan are rotated by a driving force of the motor, and the heater 18 is operated.

As the drum 12 is rotated, the objects to be dried in the drum 12 are lifted up and subsequently dropped by the lifter 11. The blower fan sucks external air, and the external air is heated to high-temperature and low-humidity air by passing through the heater 18 and then flows into the drum 12 through the inflow duct 20.

The high-temperature and low-humidity air supplied into the drum 12 directly interacts with the objects to be dried and performs a function of drying the objects to be dried. While drying the objects to be dried, the high-temperature and low-humidity air is transformed into low-temperature and high-humidity air. The low-temperature and high-humidity air moves toward the front of the drum 12, and is exhausted out of the dryer through the exhaust duct 27.

However, in the above conventional dryer, because the air suction and exhaust are performed by only one blower fan, the amount of air passing through the drum is not sufficient. Therefore, it takes much time to completely dry the objects to be dried, and maintenance costs due to long operation time are increased.

Also, because manufacturing the fan housing of the conventional dryer requires the welding process of the main body and the cover, it is difficult to reduce time and costs required to assemble the fan housing. Further, if a gap is formed between the main body and the cover by an error during the welding process, the air passing through the fan housing leaks out of the fan housing, and it is difficult to find out the location of the leak point.

### BRIEF SUMMARY OF THE INVENTION

The present invention has been made in view of the foregoing problems of the prior art, and it is an aspect of the present invention to provide a dryer which has a structure capable of circulating air sufficiently and smoothly, thereby reducing time and costs required for drying operation.

It is another aspect of the present invention to provide a dryer which can reduce the number of components.

It is yet another aspect of the present invention to provide a dryer which can easily assemble a fan housing and securely maintain air tightness of the fan housing.

Consistent with one aspect, an exemplary embodiment of the present invention provides an insertion coupling type fan housing comprising: a main body which houses an exhaust fan and is formed with an inflow hole; a cover which is coupled to the main body to form an airtight space and is formed with an outflow hole; a coupling member which is formed at a circumference of the cover; a coupling hole which is formed at a circumference of the main body correspondingly to the coupling member so that the coupling member is inserted into the coupling hole; and a sealing part which is mounted between the main body and the cover to prevent air from leaking through a gap between the main body and the cover.

Preferably, the inflow hole is formed at a front surface of the main body, the exhaust fan is mounted in the main body while opposing the inflow hole, and the main body is formed with a guide part which extends toward the outflow hole.

Preferably, the sealing part includes a rib which is formed along the circumference of the cover, an insertion groove which is formed along the circumference of the main body correspondingly to the rib so that the rib is inserted into the insertion groove, and a sealing member which is interposed between the rib and the insertion groove.

Preferably, the rib is formed with tapered surfaces at both sides such that a thickness of the rib becomes decreased as the rib progresses outward.

Preferably, the coupling member includes a hook.

Consistent with another aspect, an exemplary embodiment of the present invention provides a dryer comprising: an insertion coupling type fan housing which includes: a main body which houses an exhaust fan and is formed with an inflow hole; a cover which is coupled to the main body to form an airtight space and is formed with an outflow hole; a coupling member which is formed at a circumference of the cover; a coupling hole which is formed at a circumference of the main body correspondingly to the coupling member so that the coupling member is inserted into the coupling hole; and a sealing part which is mounted between the main body and the cover to prevent air from leaking through a gap between the main body and the cover.

Preferably, the inflow hole is formed at a front surface of the main body, the exhaust fan is mounted in the main body while opposing the inflow hole, and the main body is formed with a guide part which extends toward the outflow hole.

Preferably, the sealing part includes a rib which is formed along the circumference of the cover, an insertion groove which is formed along the circumference of the main body correspondingly to the rib so that the rib is inserted into the insertion groove, and a sealing member which is interposed between the rib and the insertion groove.

Preferably, the rib is formed with tapered surfaces at both sides such that a thickness of the rib becomes decreased as the rib progresses outward.

Preferably, the coupling member includes a hook.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a constitution of a conventional dryer;

FIG. 2 is a perspective view illustrating a constitution of a conventional dryer;

FIG. 3 is a rear perspective view illustrating a constitution of a dryer in accordance with an exemplary embodiment of the present invention;

FIG. 4 is a front perspective view illustrating a constitution of a dryer in accordance with an exemplary embodiment of the present invention;

FIG. 5 is a rear perspective view illustrating a suction hole and an exhaust hole of a dryer in accordance with an exemplary embodiment of the present invention;

FIG. 6 is an exploded perspective view illustrating a coupling structure of an insertion coupling type fan housing of a dryer in accordance with an exemplary embodiment of the present invention;

FIG. 7 is a sectional view illustrating a coupling structure of an insertion coupling type fan housing of a dryer in accordance with an exemplary embodiment of the present invention;

FIG. 8 is an enlarged view of an “A” portion in FIG. 7;

FIG. 9 is a plan view illustrating a suction passage of a dryer in accordance with an exemplary embodiment of the present invention;

FIG. 10 is a side-sectional view illustrating a suction passage of a dryer in accordance with an exemplary embodiment of the present invention; and

FIG. 11 is a plan view illustrating an exhaust passage of a dryer in accordance with an exemplary embodiment of the present invention.

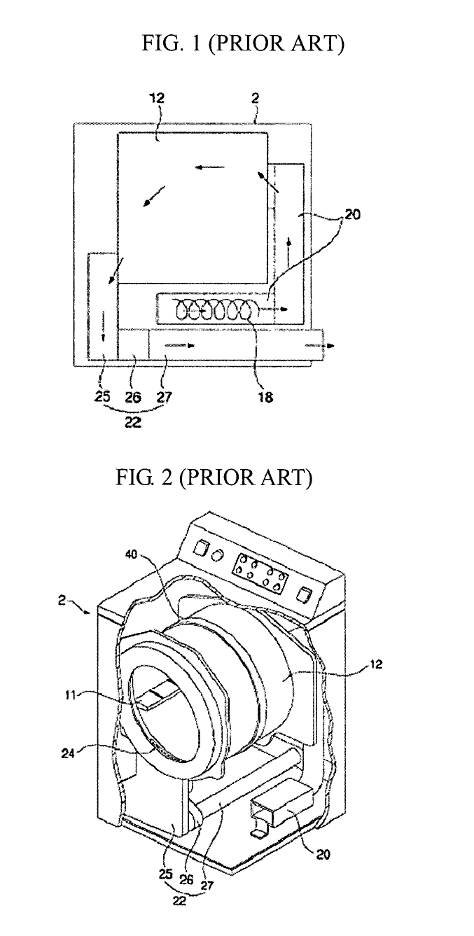

### DETAILED DESCRIPTION OF THE INVENTION

Preferred embodiments of the present invention will now be described in detail with reference to the accompanying drawings.

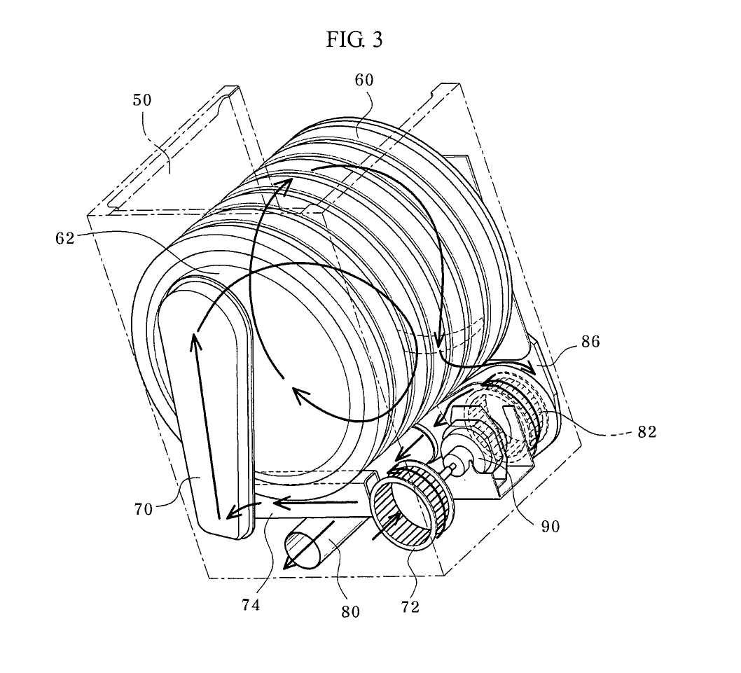

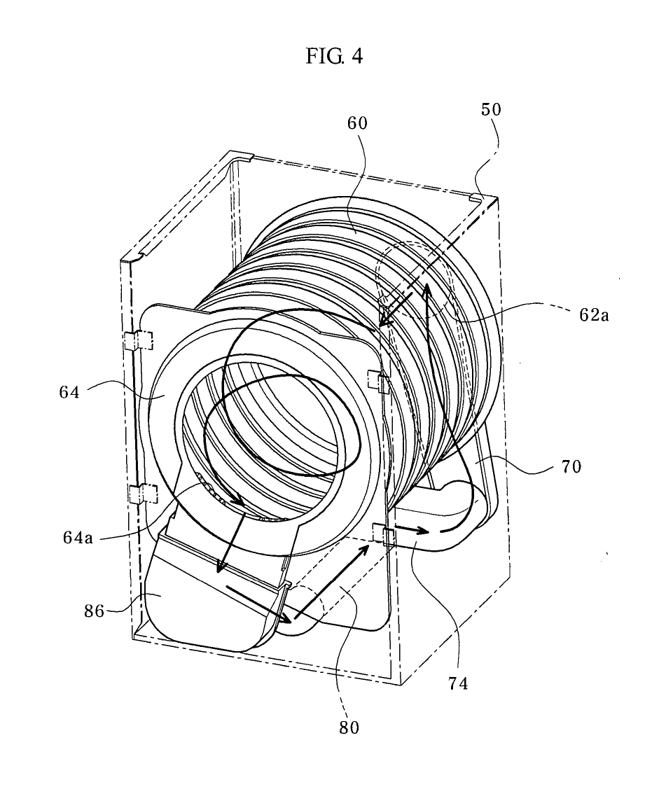

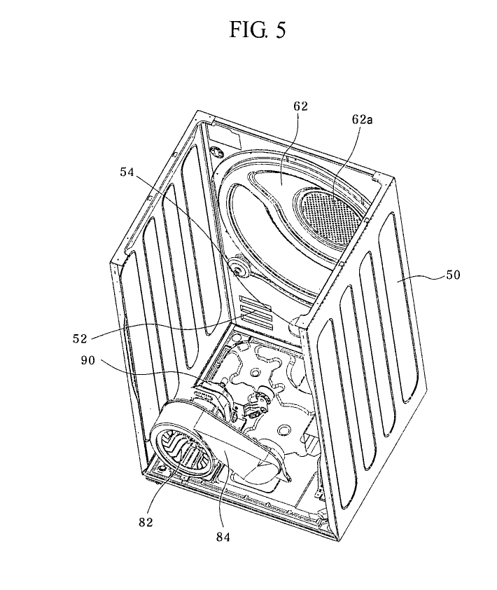

FIG. 3 is a rear perspective view illustrating a constitution of a dryer in accordance with an exemplary embodiment of the present invention, FIG. 4 is a front perspective view illustrating the constitution of the dryer, and FIG. 5 is a rear perspective view illustrating a suction hole and an exhaust hole of the dryer.

As shown in the drawings, the dryer in accordance with an exemplary embodiment of the present invention comprises: a cabinet 50 which provides a certain space and is formed with an opening, a suction hole 52 and an exhaust hole 54; a drum 60 which is rotatably mounted in the cabinet 50 while opposing the opening to contain objects to be dried; a suction fan 72 which is mounted in the cabinet 50 while opposing the suction hole 52; a suction duct 70 which is mounted between the drum 60 and the suction fan 72 to guide air sucked by the suction fan 72 into the drum 60; a heater 74 which is mounted between the suction duct 70 and the suction fan 72; an exhaust fan 82 which is mounted between the drum 60 and the exhaust hole 54; an exhaust duct 80 which is mounted between the exhaust fan 82 and the exhaust hole 54; and a driving motor 90 to which rotating shafts of the exhaust fan 82 and the suction fan 72 are connected.

If power is applied to the driving motor 90 by manipulation of a user, the suction fan 72 and the exhaust fan 82 are rotated to generate air circulation. The air sucked through the suction hole 52 is heated while passing through the heater 74, and the heated air is supplied into the drum 60. The heated air entering the drum 60 directly interacts with the wet objects to be dried contained in the drum 60 and dries the same.

The air in the drum 60 is exhausted out of the cabinet 50 by the exhaust fan 82 through the exhaust duct 80 and the exhaust hole 54 of the cabinet 50.

The suction hole 52 and the exhaust hole 54, as shown in FIG. 5, are formed near a lower end of a rear surface of the cabinet 50. Preferably, the exhaust hole 54 is formed at a lower middle portion, and the suction hole 52 is formed near a lower corner.

The drum 60 is formed in a cylindrical shape which has an opened front portion and an opened rear portion. The front portion of the drum 60 opposes the opening of the cabinet 50, and the rear portion of the drum 60 is rotatably coupled to a supporting panel 62 having a group of through-holes 62a.

A gasket 64 is mounted between a front end of the drum 60 and the opening of the cabinet 50. The gasket 64 is formed with an air outlet 64a at its bottom.

An extension duct 86 which extends toward the exhaust fan 82 is communicatingly connected to the air outlet 64a of the gasket 64. An insertion coupling type fan housing 84, in which the exhaust fan 82 is rotatably mounted, is mounted between the extension duct 86 and the exhaust duct 80.

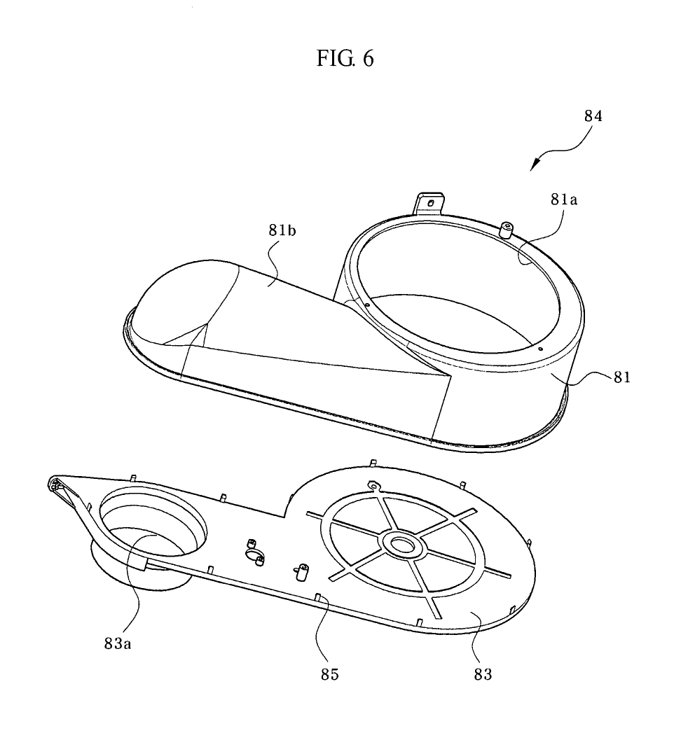

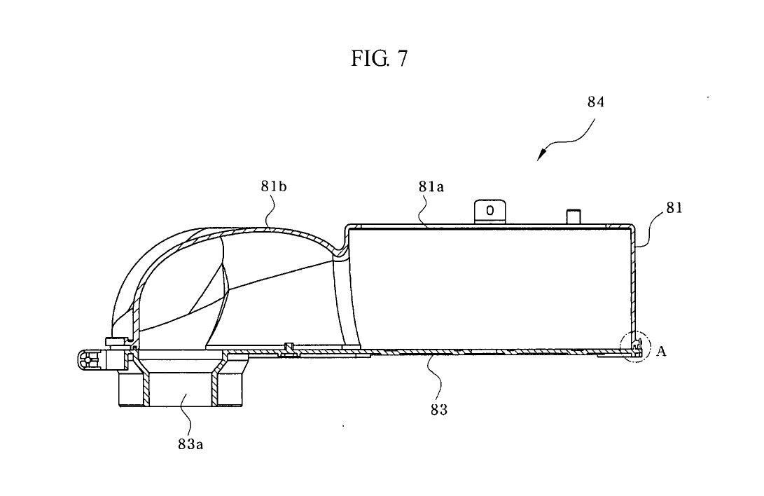

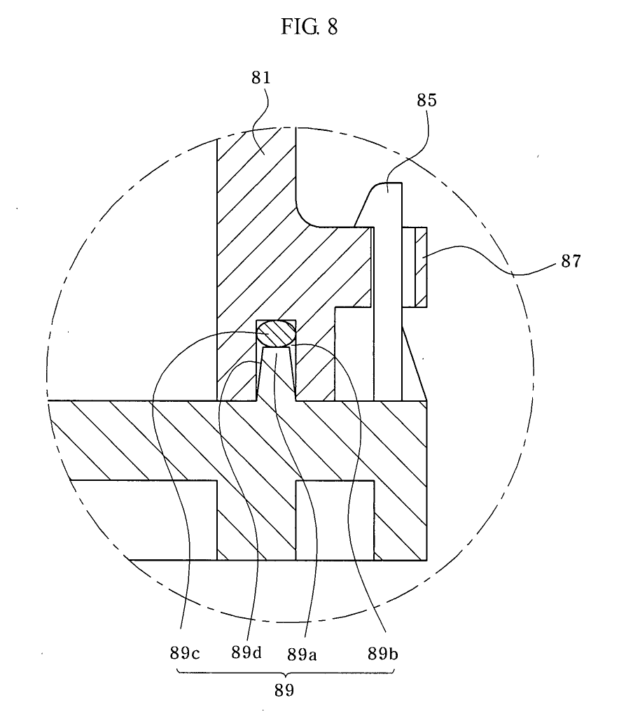

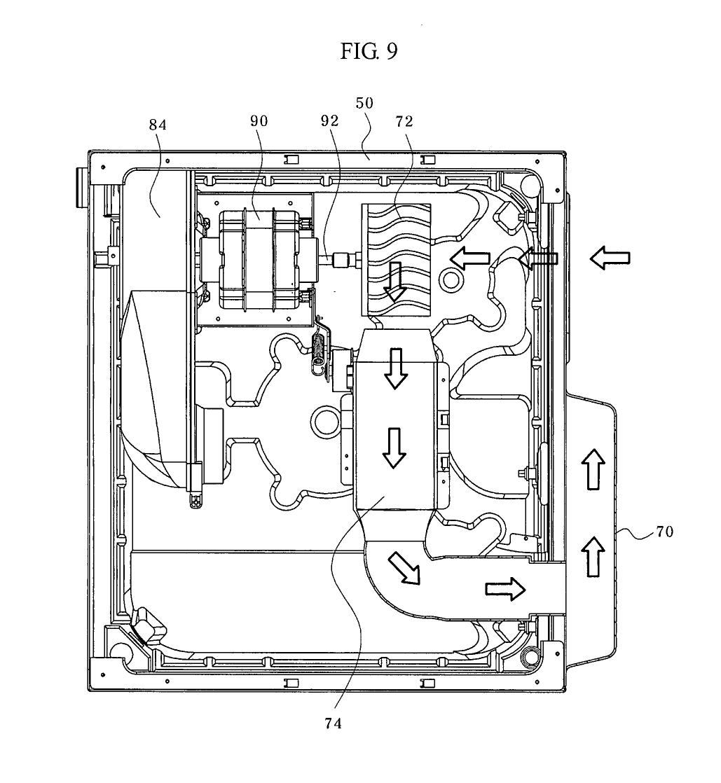

FIGS. 6 and 7 are an exploded perspective view and a sectional view illustrating a coupling structure of the insertion coupling type fan housing, respectively, and FIG. 8 is an enlarged view of an “A” portion in FIG. 7.

As shown in the drawings, the insertion coupling type fan housing 84 includes a main body 81 which houses the exhaust fan 82 and is formed with an inflow hole 81a, a cover 83 which is coupled to the main body 81 to form an airtight space and is formed with an outflow hole 83a, a plurality of coupling members 85 which are formed at a circumference of the cover 83, a plurality of coupling holes 87 which are formed at a circumference of the main body 81 correspondingly to the coupling members 85 so that the coupling members 85 can be inserted into the coupling holes 87, and a sealing part 89 which is mounted between the main body 81 and the cover 83. Preferably, the coupling member 85 includes a hook.

An assembly process of the fan housing 84 and the exhaust fan 82 includes steps of disposing the exhaust fan 82 in the main body 81, and coupling the cover 83 to the main body 81 such that the coupling members 85 formed at the circumference of the cover 83 are respectively inserted into the corresponding coupling holes 87 formed at the circumference of the main body 81.

The main body 81 includes a cylinder-shaped part having the inflow hole 81a, to which the extension duct 86 is coupled. The exhaust fan 82 is disposed in the main body 81 while opposing the inflow hole 81a. The main body 81 further includes a guide part 81b which extends from the inflow hole 81a toward the outflow hole 83a. Accordingly, the air discharged out of the drum 60 flows into fan housing 84 through an inflow hole 81a via the extension duct 86. And, the air passes through the guide part 81b via the exhaust fan 82, and moves into the exhaust duct 80 through the outflow hole 83a.

The sealing part 89 mounted between the main body 81 and the cover 83 prevents leak of the air passing through the fan housing 84. The sealing part 89 includes a rib 89a which is formed along the circumference of the cover 83, an insertion groove 89b which is formed along the circumference of the main body 81 correspondingly to the rib 89a so that the rib 89a is inserted into the insertion groove 89b, and a sealing member 89c which is interposed between the rib 89a and the insertion groove 89b. As shown in FIG. 8, the rib 89a is formed with tapered surfaces 89d at its both sides such that a thickness of the rib 89a becomes decreased as it progresses outward.

When assembling the main body 81 and the cover 83, the coupling members 85 of the cover 83 are inserted into the coupling holes 87 of the main body 81. At this time, the rib 89a of the cover 83 can be easily inserted into the insertion groove 89b of the main body 81 by the tapered surfaces 89d formed at the both sides of the rib 89a. The sealing member 89c made of elastic material, which is disposed between a top of the rib 89a and an inner surface of the insertion groove 89b, more securely prevents leak of the air passing through the fan housing 84.

The suction duct 70 extends from the rear lower portion of the cabinet 50 corresponding to the heater 74 to the rear upper portion of the cabinet 50 corresponding to the through-holes 62a. The air sucked by the suction fan 72 is heated while passing through the heater 74, and the heated air moves to the upper portion of the cabinet 50 through the suction duct 70 and then flows into the drum 60 through the through-holes 62a. At the same time, the drum 60 connected to the driving motor 90 by a belt 96 is rotated so as to increase the contact area between the hot air and the objects to be dried. By the above-described process, the drying operation of the dryer is performed.

Meanwhile, the driving motor 90 is configured to include a first rotating shaft 92 mounted to one side and a second rotating shaft 94 mounted to the other side. The suction fan 72 is connected to the first rotating shaft 92 of the driving motor 90, and the exhaust fan 82 is connected to the second rotating shaft 94 of the driving motor 90. Accordingly, when power is applied to the driving motor 90, the first rotating shaft 92 and the second rotating shaft 94 are rotated at the same time.

The belt 96 is mounted to the first rotating shaft 92 of the driving motor 90 and the drum 60 so as to transmit the driving force of the driving motor 90 to the drum 60. Accordingly, when power is applied to the driving motor 90, the suction fan 72, the exhaust fan 82 and the drum 60 are simultaneously rotated. In other words, by only one motor being driven, the rotation of the drum 60 and the air circulation inward and outward of the drum 60 are performed together.

Hereinafter, an operation of the dryer according to the present invention will be described.

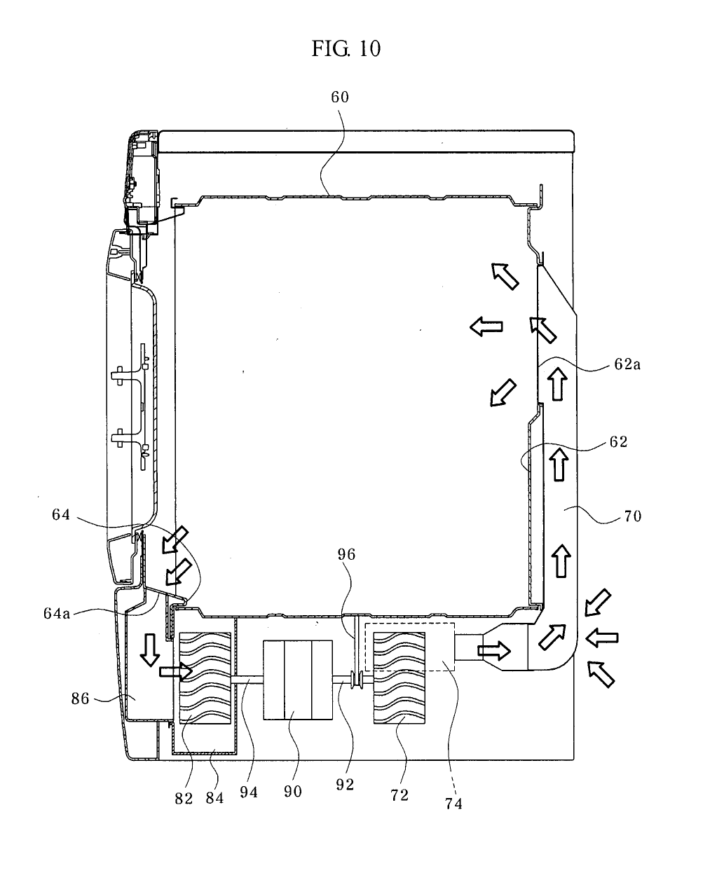

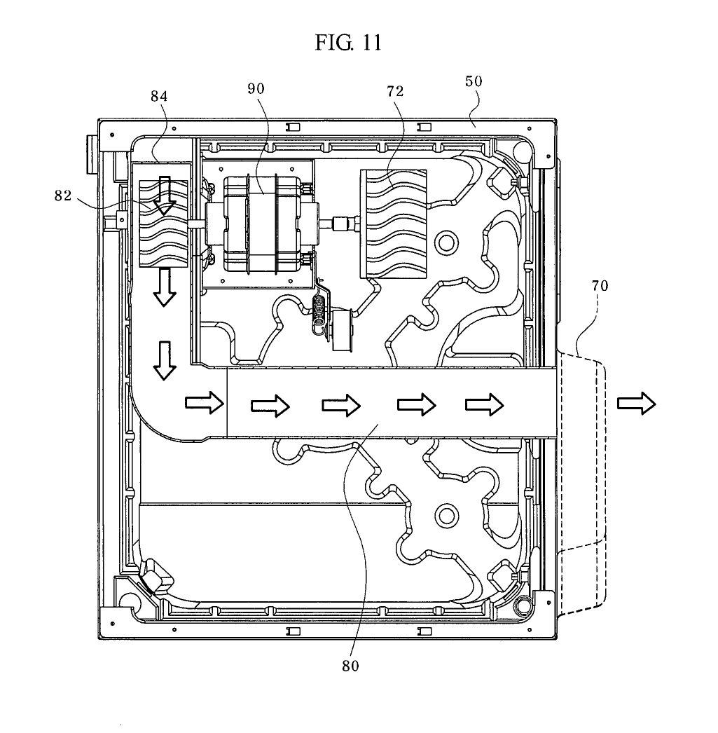

FIGS. 9 and 10 are a plan view and a side-sectional view, respectively, illustrating a suction passage of the dryer in accordance with an exemplary embodiment of the present invention, and FIG. 11 is a plan view illustrating an exhaust passage of the dryer in accordance with an exemplary embodiment of the present invention.

When power is applied to the driving motor 90 by the manipulation of the user, the suction fan 72 and the drum 60 connected to the first rotating shaft 92 and the exhaust fan 82 connected to the second rotating shaft 94 are rotated. The air sucked into the cabinet 50 through the suction hole 52 by the suction fan 72, as shown in FIG. 6, is blown around a periphery of the suction fan 72, and heated while passing through the heater 74. The heated air by the heater 74, as shown in FIG. 7, moves to the upper portion of the cabinet 50 along the suction duct 70 which extends lengthwise vertically at the rear surface of the cabinet 50.

Afterwards, the air flowing into the drum 60 through the through-holes 62a swirls in the drum 60 and interacts with the objects to be dried to dry the same. The air used for drying the objects to be dried flows out of the drum 60 through the air outlet 64a formed at the gasket 64 which is mounted between the opening of the drum 60 and an inner wall of the cabinet 50. The air flowing out of the drum 60 moves into the fan housing 84 containing the exhaust fan 82 via the extension duct 86, and moves along the exhaust duct 80 from the fan housing 84. Finally, the air is exhausted out of the cabinet 50 through the exhaust hole 54. In the above exhaust process, the air flowing through the inflow hole 81a, the guide part 81b and the outflow hole 83a of the fan housing 84 is prevented from leaking by the sealing part 89 including the rib 89a, the insertion groove 89b and the sealing member 89c, so that the air can be perfectly exhausted out of the cabinet 50 along the exhaust duct 80.

Since the dryer according to the present invention is configured such that the suction fan, the exhaust fan and the drum can be rotated by one driving motor, the air circulation inward and outward of the drum 60 can be performed smoothly with the smaller number of components. Also, the assembly process of the exhaust fan and the fan housing is facilitated, and the leak of the exhaust air is prevented.

As apparent from the above description, according to the dryer of the present invention, since the suction fan for sucking the air into the drum and the exhaust fan for exhausting the air in the drum out of the cabinet are separately provided, the air circulation can be achieved smoothly, and time and costs required for the drying operation can be reduced.

Also, since the suction fan, the exhaust fan and the drum are connected to one driving motor, the air circulation inward and outward of the drum can be achieved smoothly by the suction fan and the exhaust fan, and time required for the drying operation can be decreased.

Also, since the suction fan and the exhaust fan are driven by one driving motor, the number of components can be reduced, and manufacturing costs can be curtailed.

Also, the fan housing is constituted by coupling the main body and the cover by inserting the coupling member of the cover into the coupling hole of the main body, thereby increasing assembly efficiency, and reducing time and costs required to assemble the exhaust fan and the fan housing.

Also, the air is prevented from leaking out of the fan housing by the sealing part including the rib, the insertion groove and the sealing member, thereby enhancing air blowing efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An insertion coupling type fan housing comprising:
a main body which houses an exhaust fan and is formed with an inflow hole;
a cover which is coupled to the main body to form an airtight space and is formed with an outflow hole;
a coupling member which is formed at a circumference of the cover;
a coupling hole which is formed at a circumference of the main body correspondingly to the coupling member so that the coupling member is inserted into the coupling hole; and
a sealing part which is mounted between the main body and the cover to prevent air from leaking through a gap between the main body and the cover.

2. The insertion coupling type fan housing according to claim 1, wherein the inflow hole is formed at a front surface of the main body, the exhaust fan is mounted in the main body while opposing the inflow hole, and the main body is formed with a guide part which extends toward the outflow hole.

3. The insertion coupling type fan housing according to claim 1, wherein the sealing part includes a rib which is formed along the circumference of the cover, an insertion groove which is formed along the circumference of the main body correspondingly to the rib so that the rib is inserted into the insertion groove, and a sealing member which is interposed between the rib and the insertion groove.

4. The insertion coupling type fan housing according to claim 3, wherein the rib is formed with tapered surfaces at both sides such that a thickness of the rib becomes decreased as the rib progresses outward.

5. The insertion coupling type fan housing according to claim 1, wherein the coupling member includes a hook.

6. A dryer comprising:
an insertion coupling type fan housing which includes:
a main body which houses an exhaust fan and is formed with an inflow hole;
a cover which is coupled to the main body to form an airtight space and is formed with an outflow hole;
a coupling member which is formed at a circumference of the cover;
a coupling hole which is formed at a circumference of the main body correspondingly to the coupling member so that the coupling member is inserted into the coupling hole; and
a sealing part which is mounted between the main body and the cover to prevent air from leaking through a gap between the main body and the cover.

7. The dryer according to claim 6, wherein the inflow hole is formed at a front surface of the main body, the exhaust fan is mounted in the main body while opposing the inflow hole, and the main body is formed with a guide part which extends toward the outflow hole.

8. The dryer according to claim 6, wherein the sealing part includes a rib which is formed along the circumference of the cover, an insertion groove which is formed along the circumference of the main body correspondingly to the rib so that the rib is inserted into the insertion groove, and a sealing member which is interposed between the rib and the insertion groove.

9. The dryer according to claim 8, wherein the rib is formed with tapered surfaces at both sides such that a thickness of the rib becomes decreased as the rib progresses outward.

10. The dryer according to claim 6, wherein the coupling member includes a hook.
